(19) United States
(12) Patent Application Publication
(10) Pub. No.: US 2016/0302499 A1
(43) Pub. Date: Oct. 20, 2016

(54) HAND-WARMER ASSEMBLY AND METHOD OF USING THE SAME

(71) Applicant: Michael McMahon, Natick, MA (US)

(72) Inventor: Michael McMahon, Natick, MA (US)

(21) Appl. No.: 15/132,014

(22) Filed: Apr. 18, 2016

Related U.S. Application Data
(60) Provisional application No. 62/149,397, filed on Apr. 17, 2015.
(60) Provisional application No. 62/168,954, filed on Jun. 1, 2015.

(51) Int. Cl. A41D 19/00; A01K 27/00; A01K 29/00; A41D 19/01

(52) U.S. Cl. CPC A41D 19/0048; A41D 19/01; A41D 19/002; A01K 27/003; A01K 29/00

(57) ABSTRACT

A hand-warmer assembly and method of using the same. According to one embodiment, the hand-warmer assembly includes a hand-warmer and a leash connector. The hand-warmer may include a sleeve or a mitt having an open end for receiving a user's hand and a closed end. A pocket for holding personal effects may be provided on the exterior of the hand-warmer. A closure mechanism, such as a drawstring, may be provided to close the open end around the user's wrist or arm. The leash connector may include a strap and a clasp. The strap passes through the closed end of the hand-warmer, with a first end external to the hand-warmer and a second end within the hand-warmer. The first end of the strap is coupled to the clasp, which may be secured to a pet collar or leash. The second end of the strap forms at least one loop.

### CROSS-REFERENCE TO RELATED APPLICATIONS

The present application claims the benefit under 35 U.S.C. 119(e) of U.S. Provisional Patent Application No. 62/149,397, inventor Michael McMahon, filed Apr. 17, 2015, and U.S. Provisional Patent Application No. 62/168,954, inventor Michael McMahon, filed Jun. 1, 2015, the disclosures of both of which are incorporated herein by reference.

### BACKGROUND OF THE INVENTION

The present invention relates generally to hand-warmers and relates more particularly to a novel hand-warmer assembly and to a method of using the same.

Many people wish to keep their hands warm, especially when engaged in outdoor activities during periods of cold weather. Such a wish is particularly true for many people who walk dogs or other pets outdoors.

Thus far, various approaches have been taken in an effort to address this problem, such approaches including the following:

In U.S. Pat. No. 8,534,233 B1, inventors Han et al., issued Sep. 17, 2013, which is incorporated herein by reference, there is disclosed a wearable apparatus for using a leash in a hands-free manner. The apparatus includes a centrally positionable connection hub connectable to the leash, first and second straps structured to extend over a person's shoulders, third and fourth straps structured to extend around a portion of a person's waist, and a back support connected to the first, second, third, and fourth straps. The first, second, third, and fourth straps are configured to removably and releasably attach to the connection hub. The apparatus further comprises a hand-warmer removably and releasably attached to the third and fourth straps.

In U.S. Pat. No. 5,435,273 A, inventors Landis et al., issued Jul. 25, 1995, which is incorporated herein by reference, there is disclosed a self-contained animal leash to securely hold a large dog or other animal on a lead, the device comprising a glove which is worn by the user having a support and attachment leash element integral with the glove and optionally removably secured to a single point of attachment with the glove.

In U.S. Patent Application Publication No. US 2011/0155076 A1, inventor Charette, published Jun. 30, 2011, which is incorporated herein by reference, there is disclosed a device to be worn over the hand of an individual while walking an animal with a retractable leash or lead. The leash mitt includes a covering having a front end, a back end, a top end, a bottom end, an outside surface and an inside surface, wherein the covering defines a pocket to house the hand of an individual and a retractable leash or lead; a first opening at the bottom end, wherein the opening has a recloseable member and has a size between about 6 inches and about 10 inches, wherein the recloseable member closes a portion of the opening to thereby leave a point of extrusion for the leash; and a second opening at the front end of the covering and defined by a lip having a size to receive the hand of the individual, wherein the lip has a securing means.

Other documents that may be of interest include the following, all of which are incorporated herein by reference: U.S. Pat. No. 8,776,267 B2, inventor Narboni-Campora, issued Jul. 15, 2014; U.S. Pat. No. 8,615,814 B1, inventor Hawkins, issued Dec. 31, 2013; U.S. Pat. No. 6,089,193, inventor Paglericcio, issued Jul. 18, 2000; U.S. Patent Application Publication No. US 2012/0160858 A1, inventor Vossman, published Jun. 28, 2012; U.S. Patent Application Publication No. US 2010/0299800 A1, inventor Jackson, Jr., published Dec. 2, 2010; and U.S. Patent Application Publication No. US 2008/0000432 A1, inventor Alhegelan, published Jan. 3, 2008.

### SUMMARY OF THE INVENTION

It is an object of the present invention to provide a novel hand-warmer assembly. According to a preferred feature of the invention, the hand-warmer assembly as described above is adapted for use in walking a pet, such as a dog. Such a hand-warmer assembly may include, for example, a pet leash adapted for connection to a pet collar or a connector adapted for connection to such a pet leash.

According to yet another preferred feature of the invention, the hand-warmer assembly as described above overcomes at least some of the shortcomings associated with existing hand-warming articles.

Therefore, according to one aspect of the invention, there is provided a hand-warmer assembly, the hand-warmer assembly comprising (a) a hand-warmer, the hand-warmer comprising a first end and a second end, the first end of the hand-warmer being open and being appropriately dimensioned to receive the hand of a user, the second end of the hand-warmer being closed; and (b) a leash connector, the leash connector comprising a strap and a coupling device, the strap having a first end and a second end, the strap passing through the second end of the hand-warmer, with the first end of the strap positioned external to the hand-warmer and coupled to the coupling device and with the second of the strap forming at least one loop within the hand-warmer.

In another, more detailed aspect of the invention, the hand-warmer may comprise a mitt.

In another, more detailed aspect of the invention, the mitt may taper in diameter from a first end of the mitt to a second end of the mitt.

In another, more detailed aspect of the invention, the hand-warmer may further comprise a closure mechanism for reducing the size of the first end of the mitt.

In another, more detailed aspect of the invention, the closure mechanism may comprise a drawstring.

In another, more detailed aspect of the invention, the hand-warmer may further comprise a pocket provided on the outside of the mitt.

In another, more detailed aspect of the invention, the hand-warmer may comprise a sleeve and an end member, the sleeve may comprise a first open end and a second open end, and the end member may be secured within the second open end of the sleeve to form the second end of the hand-warmer.

In another, more detailed aspect of the invention, the hand-warmer may further comprise a closure mechanism for reducing the size of the first open end of the sleeve.

In another, more detailed aspect of the invention, the closure mechanism may comprise at least one flap disposed at the first open end of the sleeve.

In another, more detailed aspect of the invention, the closure mechanism may further comprise a plurality of flaps disposed at the first open end of the sleeve to define a central opening of reduced size within the first open end of sleeve.

In another, more detailed aspect of the invention, the hand-warmer may further comprise a pocket provided on the outside of the sleeve.

In another, more detailed aspect of the invention, the pocket may include a sheet of material secured to the outside of the sleeve.

In another, more detailed aspect of the invention, the coupling device may comprise a clasp.

In another, more detailed aspect of the invention, the first end of the strap may be positioned just outside the second end of the hand-warmer.

In another, more detailed aspect of the invention, the first end of the strap may be positioned approximately 4-8 feet away from the hand-warmer.

In another, more detailed aspect of the invention, the second end of the strap may form a first loop of comparatively smaller size and a second loop of comparatively larger size.

According to another aspect of the invention, there is provided a hand-warmer assembly, the hand-warmer assembly comprising (a) a hand-warmer, the hand-warmer comprising a first end and a second end, the first end of the hand-warmer being open and being appropriately dimensioned to receive the hand of a user, the second end of the hand-warmer being closed; (b) a loop, the loop being positioned within the hand-warmer and being sized to permit being held by a user; (c) a strap, the strap having a first end and a second end, the first end of the strap being spaced away from the hand-warmer, the second end of the strap being permanently secured to the second end of the hand-warmer; and (d) a clasp, the clasp being coupled to the second end of the strap.

In another, more detailed aspect of the invention, the first end of the strap may be positioned approximately 4-8 feet away from the hand-warmer.

In another, more detailed aspect of the invention, the first end of the strap may be positioned just outside the hand-warmer.

It is another object of the present invention to provide a method of using such a hand-warmer assembly, for example, to walk a pet, such as a dog.

Therefore, according to one aspect of the invention, there is provided a method of leashing an animal, the method comprising the steps of (a) providing a hand-warmer assembly, the hand-warmer assembly comprising (i) a hand-warmer, the hand-warmer comprising a first end and a second end, the first end of the hand-warmer being open and being appropriately dimensioned to receive the hand of a user, the second end of the hand-warmer being closed; (ii) a loop, the loop being positioned within the hand-warmer and being sized to permit being held by a user; (iii) a strap, the strap having a first end and a second end, the first end of the strap being spaced approximately 4-8 feet away from the hand-warmer, the second end of the strap being permanently secured to the second end of the hand-warmer; and (iv) a clasp, the clasp being coupled to the first end of the strap; and (b) attaching the clasp to one of an animal collar attached to an animal or a leash attached to an animal.

According to another aspect of the invention, there is provided a method leashing an animal, the method comprising the steps of (a) providing a hand-warmer assembly, the hand-warmer assembly comprising (i) a hand-warmer, the hand-warmer comprising a first end and a second end, the first end of the hand-warmer being open and being appropriately dimensioned to receive the hand of a user, the second end of the hand-warmer being closed; (ii) a loop, the loop being positioned within the hand-warmer and being sized to permit being held by a user; (iii) a strap, the strap having a first end and a second end, the first end of the strap being spaced away from the hand-warmer, the second end of the strap being permanently secured to the second end of the hand-warmer; and (iv) a clasp, the clasp being coupled to the second end of the strap; and (b) attaching the clasp to an animal leash attached to an animal.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a front perspective view of a first embodiment of a hand-warmer assembly constructed according to the teachings of the present invention;

FIG. 2 is a rear perspective view of the hand-warmer assembly of FIG. 1;

FIG. 3 is a top view of the hand-warmer assembly of FIG. 1;

FIG. 4 is an enlarged fragmentary top view of the hand-warmer assembly of FIG. 1;

FIG. 5 is a side view, broken away in part, of the hand-warmer assembly of FIG. 1;

FIG. 6 is a rear perspective view of a second embodiment of a hand-warmer assembly constructed according to the teachings of the present invention;

FIG. 7 is a front perspective view of the hand-warmer assembly of FIG. 6;

FIG. 8 is a top view of the hand-warmer assembly of FIG. 6;

FIG. 9 is a fragmentary side view, broken away in part, of the hand-warmer assembly of FIG. 6; and

FIG. 10 is a side view of a double eye swivel that may be used to enable the internal loop handle or the external polymer or similar material to swivel.

### DETAILED DESCRIPTION OF THE INVENTION

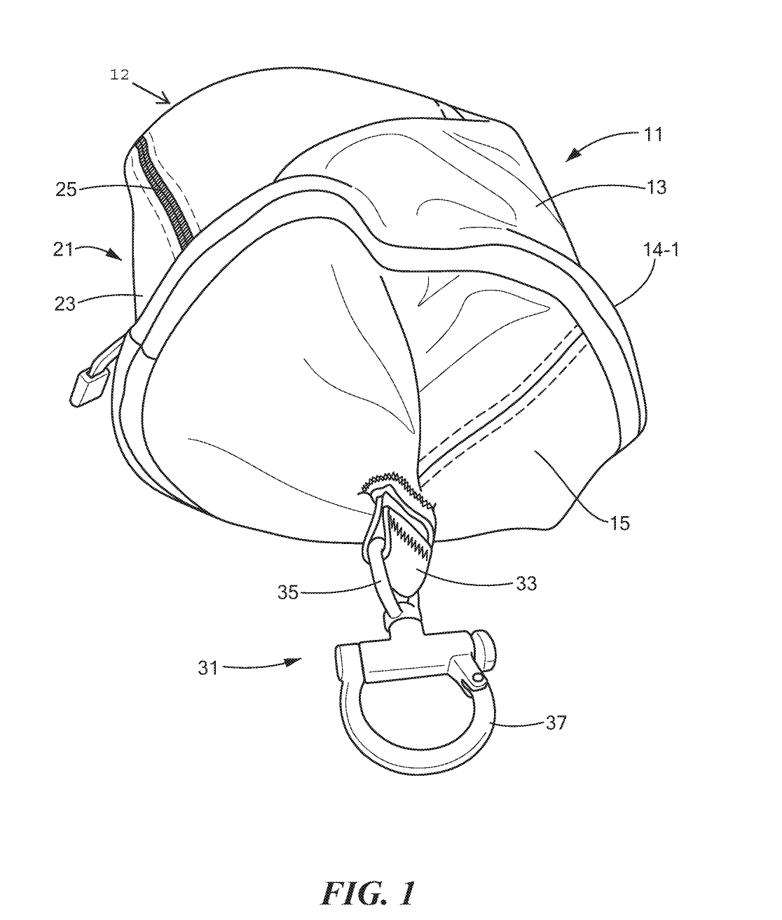

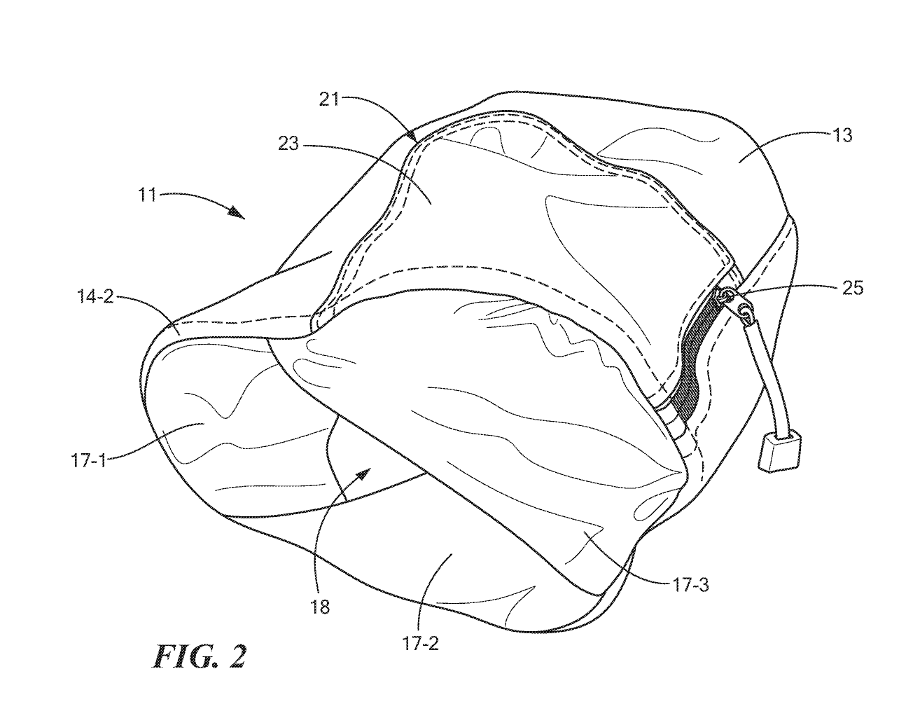

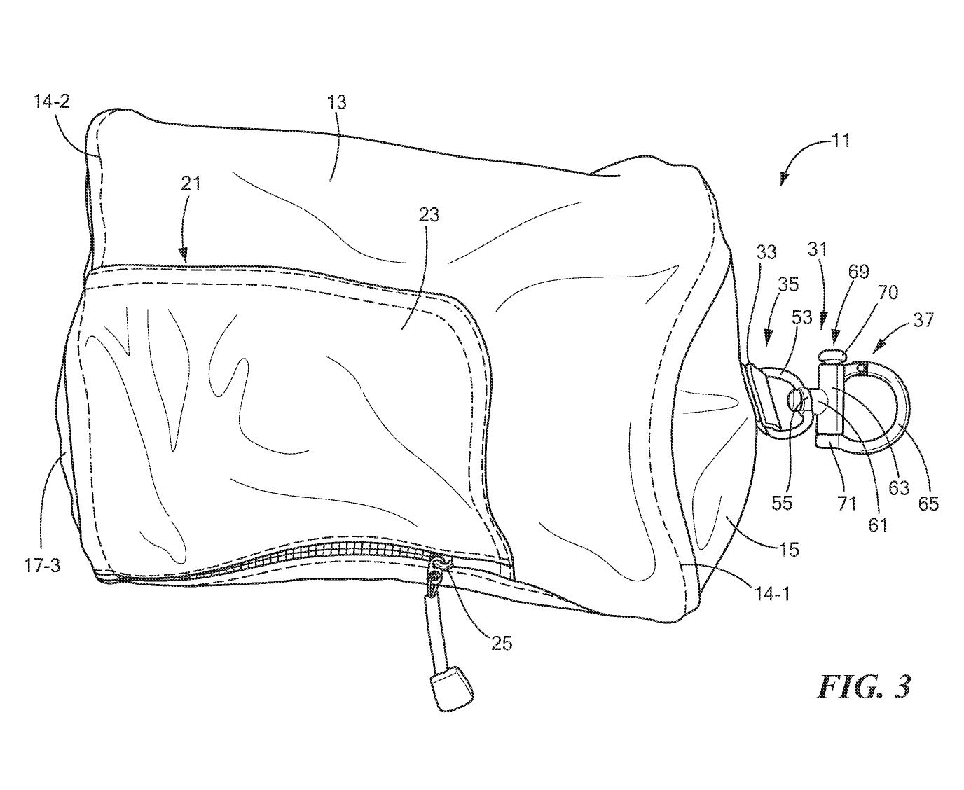

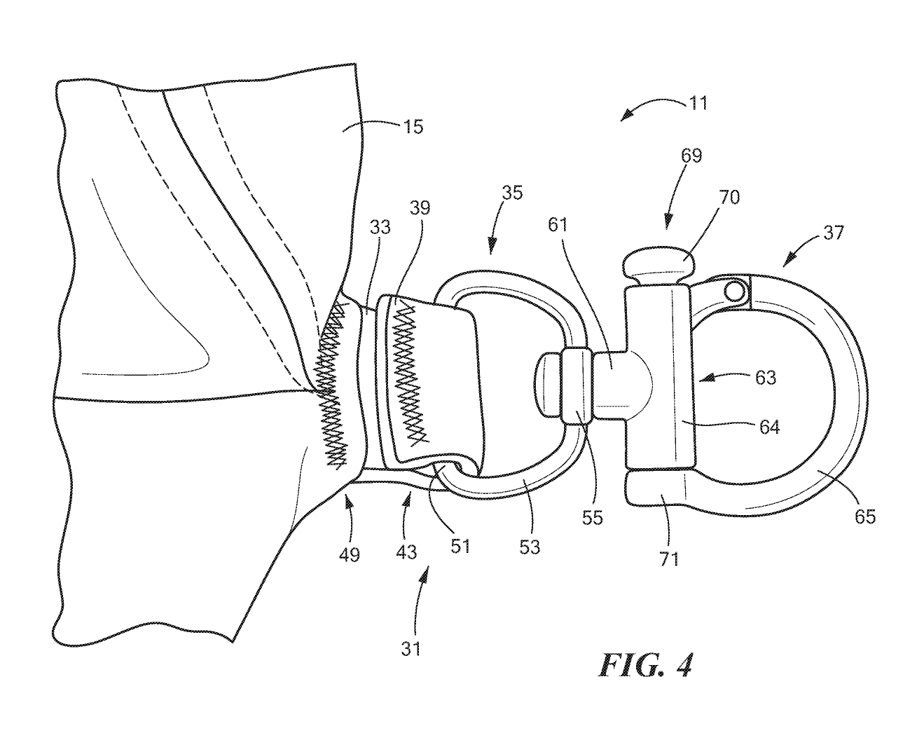

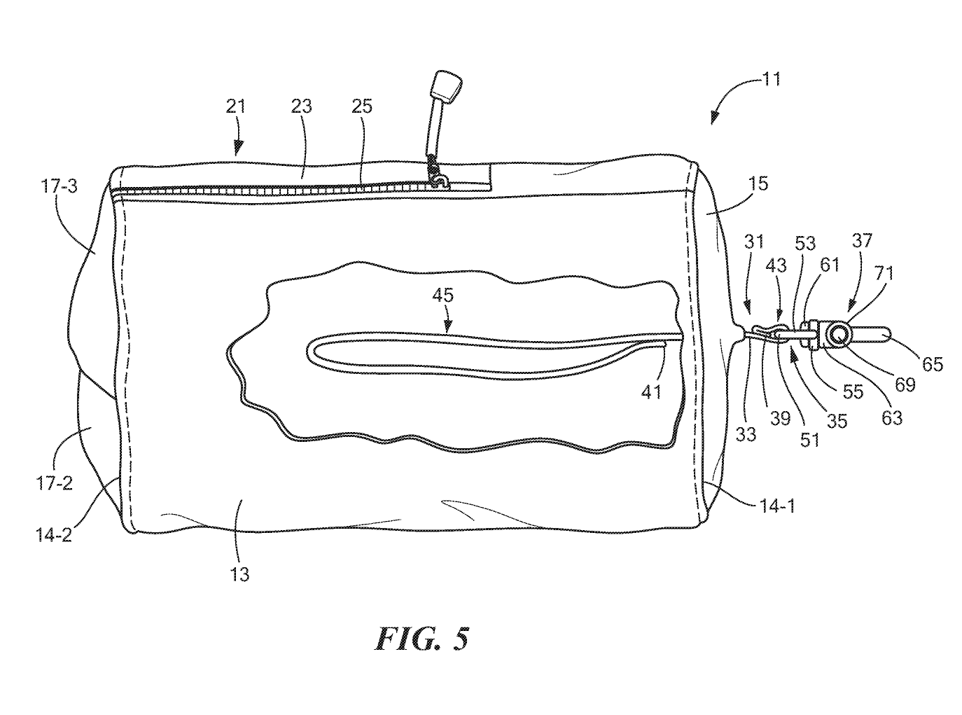

Referring now to FIGS. 1 through 5, there are shown various views of a first embodiment of a hand-warmer assembly constructed according to the present invention, the hand-warmer assembly being represented generally by reference numeral 11.

Hand-warmer assembly 11 may comprise a hand-warmer 12. Hand-warmer 12, in turn, may comprise a sleeve 13. Sleeve 13, which may be made of, lined with, or otherwise include a suitable cold-weather clothing material, such as fleece, may be a generally cylindrical, tubular member having a pair of open ends 14-1 and 14-2. Sleeve 13 may be axially and/or radially rigid or flexible but preferably is both axially and radially flexible. Sleeve 13 may be formed by rolling a generally rectangular sheet of clothing material until one of its longitudinal edges overlaps the other longitudinal edge and then by sewing or otherwise securing the sheet to itself in the area of overlap. Sleeve 13 may have a length and a diameter that are suitable for receiving the covered or uncovered hand and wrist of a user. At the same time, sleeve 13 may be appropriately dimensioned to minimize the amount of unoccupied space within sleeve 13 when sleeve 13 is worn by a user, thereby minimizing the amount of cold air that may be present within sleeve 13.

Hand-warmer 12 may also comprise an end member 15. End member 15 may be made of, lined with, or otherwise include a suitable cold-weather clothing material, such as fleece, and may be made of the same material as sleeve 13. End member 15, which may have a shape complementary to that of open end 14-1 of sleeve 13, may be positioned at open end 14-1 of sleeve 13 and may be sewn or otherwise secured to sleeve 13 within open end 14-1, thereby essentially closing open end 14-1 of sleeve 13.

Hand-warmer 12 may additionally comprise a plurality of flaps 17-1 through 17-3. Flaps 17-1 through 17-3, each of which may be generally semi-circular in shape and may be made of a flexible, lightweight material, such as a synthetic fabric, may be sewn or otherwise secured to the periphery of open end 14-2 of sleeve 13. Flaps 17-1 through 17-3 may be arranged around the periphery of open end 14-2 to define a generally central opening 18 of reduced size within open end 14-2 of sleeve 13. In this manner, the flow of air into sleeve 13 when sleeve 13 is worn by a user may be diminished. Alternatively, instead of using flaps 17-1 through 17-3, hand-warmer 12 may employ other types of mechanisms for reducing the size of open end 14-2 of sleeve 13. Such a mechanism could include, for example, a drawstring closure.

Hand-warmer 12 may further comprise a pocket 21 provided on the outside of sleeve 13 proximate to open end 14-2. Pocket 21 may be suitably dimensioned to carry one or more personal effects, such as a mobile phone, a wallet, a keychain, or the like. Pocket 21 may be formed by a sheet 23 of a flexible, lightweight material, such as a synthetic fabric, that may be sewn or otherwise secured to the outside of sleeve 13. A zipper 25 or other closure mechanism may be used to selectively open and close pocket 21. Zipper 25 may be oriented so as to cause pocket 21 to be opened when zipper 25 is moved away from open end 14-2 and closed when moved in the opposite direction or so as to cause pocket 21 to be closed when zipper 25 is moved away from open end 14-2 and opened when moved in the opposite direction.

Hand-warmer assembly 11 may further comprise a leash connector 31. Leash connector 31, in turn, may comprise a strap 33, a ring 35, and a clasp 37. Strap 33, which may be an elongated flexible member made of a woven polymer or similar material, may comprise a first end 39 and a second end 41. First end 39, which may be disposed just outside of sleeve 13 and beyond end member 15, may be sewn or otherwise secured to an intermediate portion of strap 33 that may be located outside sleeve 13 at a short distance from first end 39 so as to form a loop 43. Loop 43 may be wrapped around a portion of ring 35. Second end 41, which may be disposed inside sleeve 13 proximate to end member 15, may be sewn or otherwise secured to an intermediate portion of strap 33 that may be located within sleeve 13 at a considerable distance from second end 41 so as to form a loop 45. Loop 45 may be appropriately dimensioned to receive the hand of a user (i.e., to function as a handle) and may be dimensioned, for example, to be comparable in size to the looped handle end of a pet leash. Strap 33 may pass through an opening 49 provided in end member 15 and may be sewn or otherwise secured to end member 15 around opening 49.

Ring 35, which may be conventional, may be a generally D-shaped member made of metal, plastic or another similarly suitable material. Ring 35 may include a generally straight portion 51 and a curved portion 53. Straight portion 51 may be secured within loop 43. Curved portion 53 may be shaped to include an annulus 55.

Clasp 37, which may be conventional, may comprise a first member 61, a second member 63, and a third member 65. First member 61, which may be made of metal, plastic or another similarly suitable material, may extend through annulus 55 and may be securely and rotatably mounted therewithin. Second member 63, which may be made of metal, plastic or a similarly suitable material, may be integrally formed with first member 61. Second member 63 may comprise a tubular portion 64 that may extend generally perpendicularly relative to first member 61. A plunger 69, which may be made of metal, plastic or another similarly suitable material, may be coaxially and slidably mounted within tubular portion 64 of second member 63 and may be slid relative to tubular portion 64 of second member 63 using a handle 70. A spring (not shown) may be disposed within tubular portion 64 of second member 63 and may be positioned coaxially around plunger 69 to bias plunger 69 in a direction opposite to the direction that plunger 69 may be slid using handle 70. Third member 65, which may be made of metal, plastic or a similarly suitable material, may be hingedly mounted on second member 63 and may include an annulus 71. Annulus 71 may be appropriately dimensioned to receive the end of plunger 69 opposite handle 70. To open clasp 37, for example, to permit a pet leash to be attached thereto, handle 70 may be pulled away from tubular portion 64 of second member 63, thereby causing the opposite end of plunger 69 to be sufficiently withdrawn from annulus 71 so that third member 65 may be pivoted away from the free end of second member 63. To close clasp 37, third member 65 may be pivoted towards the free end of second member 63 until the end of plunger 69 opposite handle 70 extends into annulus 71.

To use hand-warmer assembly 11, an operator may attach a pet leash to clasp 37, for example, by opening clasp 37 in the manner described above, inserting the free end of third member 65 through a looped member of the pet leash, and then by closing clasp 37. The operator may then insert his/her hand into hand-warmer 12 through opening 18 and then may grasp loop 45.

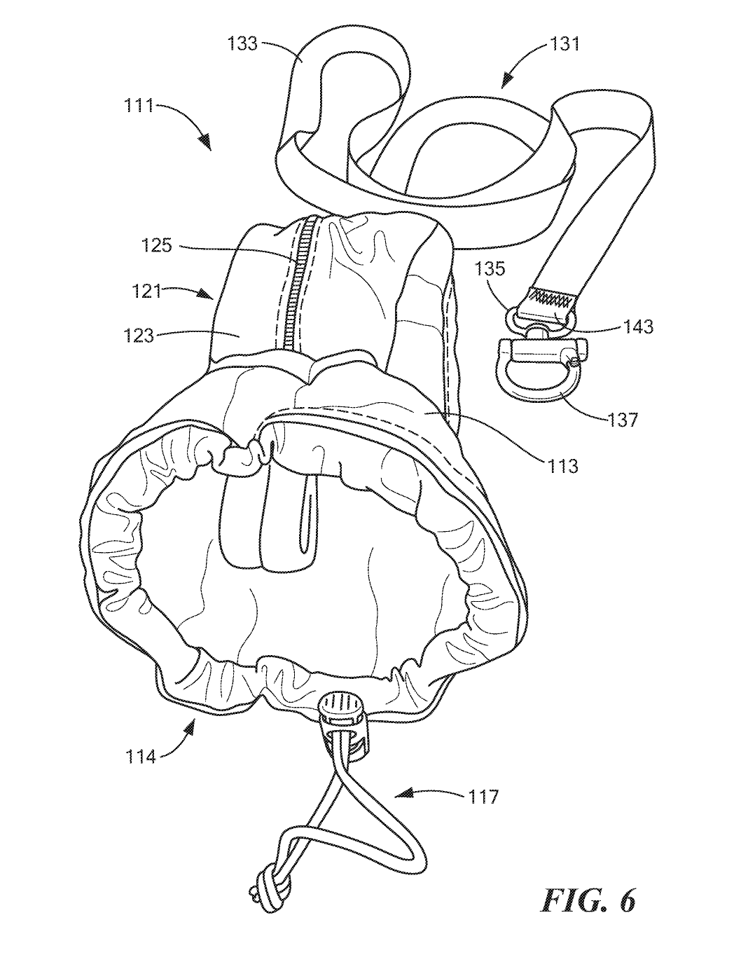

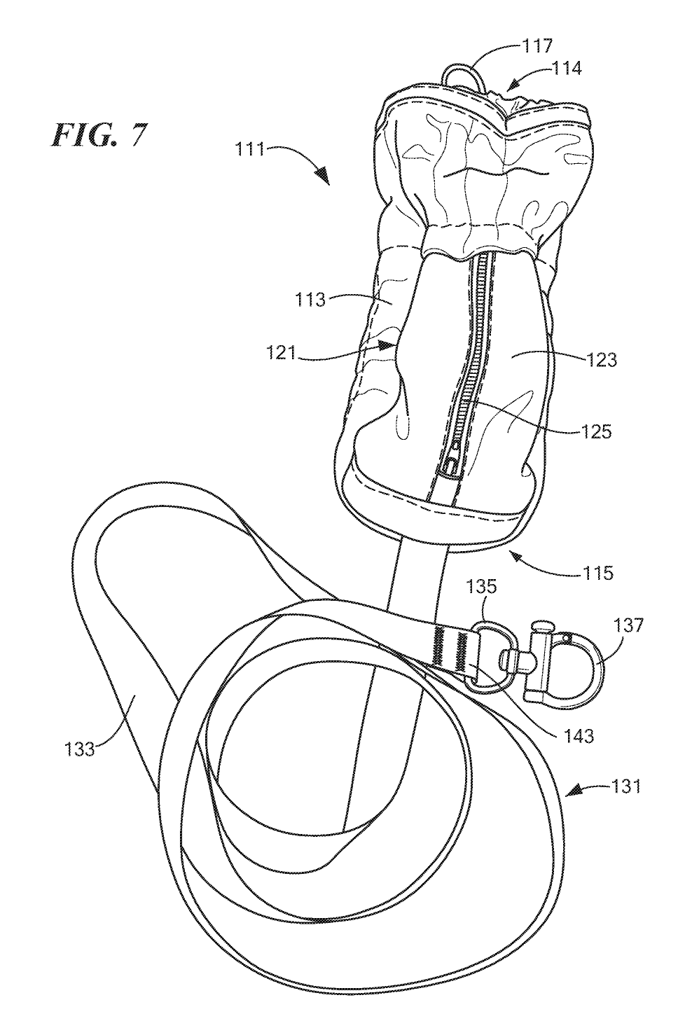

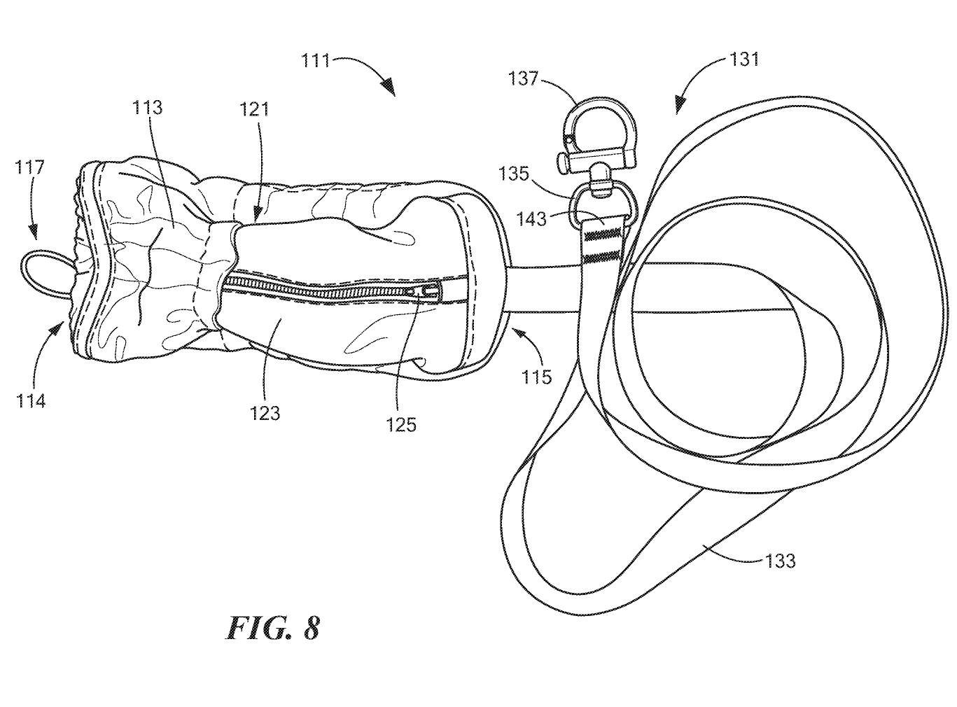

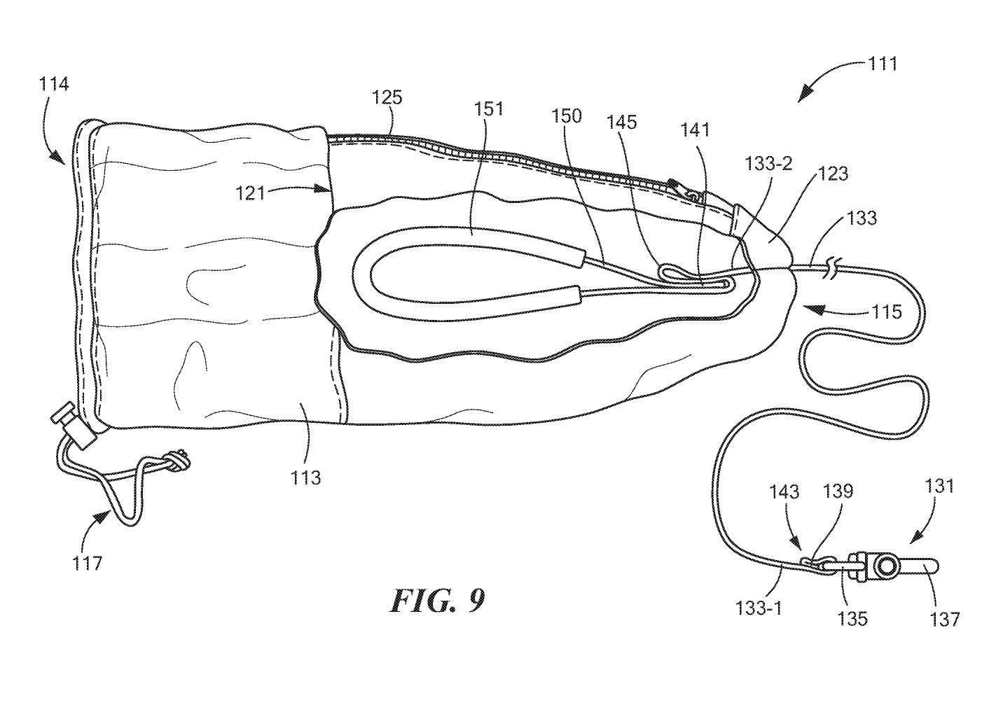

Referring now to FIGS. 6 through 9, there are shown various views of a second embodiment of a hand-warmer assembly constructed according to the present invention, the hand-warmer assembly being represented generally by reference numeral 111.

Hand-warmer assembly 111 may be similar in many respects to hand-warmer assembly 11, with some of the differences between the two assemblies being apparent from the discussion below.

Hand-warmer assembly 111 may comprise a hand-warmer or mitt 113. Mitt 113, which may be made of, lined with, or otherwise include a suitable cold-weather clothing material, such as fleece, may comprise one or more sheets of material sewn or otherwise secured together to define a generally tapered tubular member having an open end 114 of comparatively greater diameter and a closed end 115 of comparatively smaller diameter. Mitt 113 may be appropriately dimensioned to receive the covered or uncovered hand and wrist of a user while, at the same time, being appropriately dimensioned to minimize the amount of unoccupied space within mitt 113 when mitt 113 is worn by a user, thereby minimizing the amount of cold air that may be present within mitt 113. A drawstring 117 or similar mechanism may be provided at open end 114 of mitt 113 to reduce the diameter of open end 114 of mitt 113, for example, to minimize the passage of air through open end 114 when the user's hand is inserted into mitt 113. Alternatively, instead of using drawstring 117, mitt 113 could use other types of mechanisms for reducing the size of open end 114. Such a mechanism could include, for example, one or more flaps, like flaps 17-1 through 17-3 of hand-warmer assembly 11.

Hand-warmer assembly 111 may further comprise a pocket 121 located on the outside of sleeve 13 proximate to closed end 115. Pocket 121 may be suitably dimensioned to carry one or more personal effects, such as a mobile phone, a wallet, a keychain, or the like. Pocket 121 may be formed by a sheet 123 of a flexible, lightweight material, such as a synthetic fabric, that may be sewn or otherwise secured to the outside of mitt 113. A zipper 125 or other closure mechanism may be used to selectively open and close pocket 121. Zipper 125 may be oriented so as to cause pocket 121 to be opened when zipper 125 is moved away from closed end 115 and closed when moved in the opposite direction or so as to cause pocket 121 to be opened when zipper 125 is moved away from open end 114 and closed when moved in the opposite direction.

Hand-warmer assembly 111 may further comprise a leash assembly 131. Leash assembly 131, in turn, may comprise a strap 133, a ring 135, and a clasp 137. Strap 133, which may be an elongated flexible member made of a woven polymer or similar material, may pass through an opening provided in closed end 115 of mitt 113 and may be sewn or otherwise secured within said opening. Strap 133 may comprise a first portion 133-1 that is external to mitt 113 and that terminates in a first end 139 and a second portion 133-2 that is internal to mitt 113 and that terminates in a second end 141. First portion 133-1 may have a length that is typical for a pet leash and may be, for example, approximately 4-8 feet in length. First end 139 may be sewn or otherwise secured to an intermediate location on first portion 133-1 that may be located a short distance from first end 139 so as to form a loop 143. Loop 143 may be wrapped around a portion of ring 135. Second end 141 may be sewn or otherwise secured at a plurality of locations on second portion 133-2 of strap 133 so as to form a first loop 145 and a second loop 150. First loop 145 may be of comparatively smaller size, and second loop 150 may be of comparatively larger size. For example, first loop 145 may be appropriately dimensioned to receive a thumb or one or more fingers of a user, and second loop 150 may be dimensioned to receive the palm of a user's hand (and, thereby, function as a handle). Loop 150 may be at least partially covered with a cushioning material 151.

Ring 135, which may be identical to ring 35 of hand-warmer assembly 11, may be secured within loop 143 at the distal end of strap 133. Clasp 137, which may be identical to clasp 37 of hand-warmer assembly 11, may be coupled to ring 135 in a manner similar to the manner in which clasp 37 is coupled to ring 35.

To use hand-warmer assembly 111, an operator may attach a pet collar (or pet leash) to clasp 137. The operator may then insert his/her hand into mitt 113 through open end 114 and then may grasp loop 145 and/or loop 150.

One benefit to using the hand-warmer assembly of the present invention is that a user may keep his/her hand warm while walking a pet in cold weather. Moreover, while the wearing the hand warmer or mitt of the hand-warmer assembly, the user may grasp one or more of the interior loops of the hand-warmer assembly and, in so doing, may keep a firm grip on the pet leash and may keep the hand-warmer assembly from being pulled off the user's hand.

The hand-warmer assemblies described above may be modified while still coming within the scope of the present invention. For example, hand-warmer assembly 11 could be modified to include leash assembly 131, instead of leash connector 31, and hand-warmer assembly 111 could be modified to include leash connector 31, instead of leash assembly 113. Other examples of such modifications may include, but are not limited to, the following:

With respect t
the hand-warmer or mitt component,
textile material may change;
may have a cuff or other elastic closure method at the opening for the hand t
help the hand-warmer or mitt adhere t
the wrist or forearm;
may have another closure method or elastic at the wrist;
may have additional pockets on the exterior;
geometric shape may change for sizing options; and
geometric shape may change slightly to accommodate different handle styles.

With respect to the strap of the leash connector or leash assembly:
may be very short with a clasp, snap, hook, carabiner, shackle, or loop positioned near the hand-warmer or mitt component;
may be of varying lengths or adjustable with a snap, hook, carabiner, shackle, or loop positioned at the running (far) end from the hand-warmer or mitt component; and
may have additional loops, rings or swivels attached to or in line with the strap.

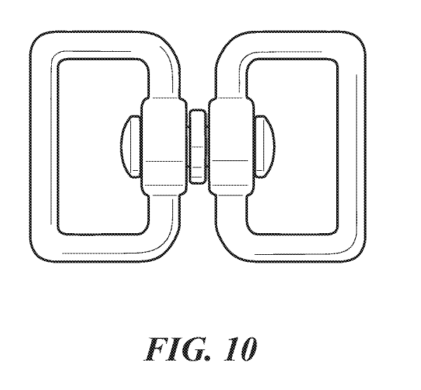

With respect to the looped handle:
may be internal to the hand-warmer pocket;
handle may be adjustable in length;
may swivel internally (e.g., may have a double eye swivel placed in the webbing channel near to the entry point (see double eye swivel shown in FIG. 10))
may have more than one handle in the hand-warmer or mitt or additional loops on the handle; and
may have integrated or removable padding for enhanced grip and/or comfort.

The embodiments of the present invention described above are intended to be merely exemplary and those skilled in the art shall be able to make numerous variations and modifications to it without departing from the spirit of the present invention. All such variations and modifications are intended to be within the scope of the present invention.

What is claimed is:

1. A hand-warmer assembly, the hand-warmer assembly comprising:
(a) a hand-warmer, the hand-warmer comprising a first end and a second end, the first end of the hand-warmer being open and being appropriately dimensioned to receive the hand of a user, the second end of the hand-warmer being closed; and
(b) a leash connector, the leash connector comprising a strap and a coupling device, the strap having a first end and a second end, the strap passing through the second end of the hand-warmer, with the first end of the strap positioned external to the hand-warmer and coupled to the coupling device and with the second end of the strap forming at least one loop within the hand-warmer.

2. The hand-warmer assembly as claimed in claim 1 wherein the hand-warmer comprises a mitt.

3. The hand-warmer assembly as claimed in claim 2 wherein the mitt tapers in diameter rom a first end of the mitt to a second end of the mitt.

4. The hand-warmer assembly as claimed in claim 2 wherein the hand-warmer further comprises a closure mechanism for reducing the size of the first end of the mitt.

5. The hand-warmer assembly as claimed in claim 4 wherein the closure mechanism comprises a drawstring.

6. The hand-warmer assembly as claimed in claim 2 wherein the hand-warmer further comprises a pocket provided on the outside of the mitt.

7. The hand-warmer assembly as claimed in claim 1 wherein the hand-warmer comprises a sleeve and an end member, the sleeve comprising a first open end and a second open end, the end member being secured within the second open end of the sleeve to form the second end of the hand-warmer.

8. The hand-warmer assembly as claimed in claim 7 wherein the hand-warmer further comprises a closure mechanism for reducing the size of the first open end of the sleeve.

9. The hand-warmer assembly as claimed in claim 8 wherein the closure mechanism comprises at least one flap disposed at the first open end of the sleeve.

10. The hand-warmer assembly as claimed in claim 8 wherein the closure mechanism further comprises a plurality of flaps disposed at the first open end of the sleeve to define a central opening of reduced size within the first open end of sleeve.

11. The hand-warmer assembly as claimed in claim 7 wherein the hand-warmer further comprises a pocket provided on the outside of the sleeve.

12. The hand-warmer assembly as claimed in claim 11 wherein the pocket includes a sheet of material secured to the outside of the sleeve.

13. The hand-warmer assembly as claimed in claim 1 wherein the coupling device comprises a clasp.

14. The hand-warmer assembly as claimed in claim 1 wherein the first end of the strap is positioned just outside the second end of the hand-warmer.

15. The hand-warmer assembly as claimed in claim 1 wherein the first end of the strap is positioned approximately 4-8 feet away from the hand-warmer.

16. The hand-warmer assembly as claimed in claim 1 wherein the second end of the strap forms a first loop of comparatively smaller size and a second loop of comparatively larger size.

17. A hand-warmer assembly, the hand-warmer assembly comprising:
(a) a hand-warmer, the hand-warmer comprising a first end and a second end, the first end of the hand-warmer being open and being appropriately dimensioned to receive the hand of a user, the second end of the hand-warmer being closed;
(b) a loop, the loop being positioned within the hand-warmer and being sized to permit being held by a user;
(c) a strap, the strap having a first end and a second end, the first end of the strap being spaced away from the hand-warmer and the second end being permanently secured to the second end of the hand-warmer; and
(d) a clasp, the clasp being coupled to the second end of the strap.

18. The hand-warmer assembly as claimed in claim 18 wherein the first end of the strap is positioned approximately 4-8 feet away from the hand-warmer.

19. A method of leashing an animal, the method comprising the steps of:
(a) providing the hand-warmer assembly of claim 17, wherein the first end of the strap is positioned approximately 4-8 feet away from the hand-warmer; and
(b) attaching the clasp to one of an animal collar attached to an animal or a leash attached to an animal.

20. A method of leashing an animal, the method comprising the steps of:
(a) providing the hand-warmer assembly of claim 17; and
(b) attaching the clasp to an animal leash attached to an animal.
